(19) United States
(12) Patent Application Publication
(10) Pub. No.: US 2004/0039728 A1
(43) Pub. Date: Feb. 26, 2004

(54) Method and system for monitoring distributed systems

(75) Inventors: Michael G. Fenlon, Nashua, NH (US); Anastasios P. Makris, Lowell, MA (US); Paul J. LaFrance, Hollis, NH (US)

Correspondence Address: TESTA, HURWITZ & THIBEAULT, LLP, HIGH STREET TOWER, 125 HIGH STREET, BOSTON, MA, 02110, US

(73) Assignee: Diring Software, Nashua, NH (US)

(21) Appl. No.: 10/647,193

(22) Filed: Aug. 22, 2003

Related U.S. Application Data
(60) Provisional application No. 60/405,387, filed on Aug. 23, 2002.

(51) Int. Cl. G06F 7/00

(52) U.S. Cl. 707/1

(57) ABSTRACT

The invention relates to systems and methods for monitoring distributed systems. More particularly, in one embodiment, the invention is directed to a method for monitoring a distributed application including one or more transactions on a network having an infrastructure. According to one embodiment, the method includes: generating a transactional path for one of the transactions; associating metrics relating to the network infrastructure with the transactional path; and providing information about the transaction to a user, based at least in part on the association between the transactional path and the metrics relating to the network infrastructure.

### CROSS-REFERENCE TO RELATED APPLICATIONS

This application claims the benefit of and priority to the co-pending U.S. Provisional Application Serial No. 60/405,387, filed Aug. 23, 2002, entitled “Method and System for Monitoring Distributed Systems,” the entire contents of which are incorporated herein by reference.

### TECHNICAL FIELD

The invention is related to systems and methods for monitoring distributed systems. More particularly, in one embodiment, the invention is directed to monitoring distributed applications. In another embodiment, the invention is directed to generating transactional paths for the distributed applications being monitored.

### BACKGROUND

Increasingly, it is becoming apparent that the most successful e-Businesses are based on existing, traditional, brick and mortar enterprises that have decided to expand onto the World Wide Web (Web) to meet market demands. E-Business, in whatever form it takes, is valued by its ability to deliver information, services and/or goods reliably to customers, and by its ability to generate revenues for the business.

Delivering information, services and/or goods to customers typically involves enabling customers to process electronically any of a plurality of business transactions. e-Business transactions may be very complex or as simple as moving an item into a virtual shopping cart. However, even the simplest of transactions may include executing multiple software applications distributed over a network, and interfacing with multiple hardware components, such as Web servers, application servers and database servers. As a result, an e-Business's ability to deliver depends on the application software logic employed to realize the transactions, the reliability and performance of the network infrastructure on which the software application logic executes, and the ability of information technology (IT) professionals to design and maintain the network so that it operates at peak performance.

Due to the distributed nature of processing over modern networks, it is difficult for IT professionals to identify all of the software and hardware elements used to implement any particular transaction. Further adding to the difficulty, software applications making up a particular transaction may execute on any of a plurality of combinations of hardware elements (such combination being termed a transactional path) and the transactional path over which a transaction executes may vary depending, for example, on the availability of hardware elements. Equally challenging is the task of identifying the transactions for which performance might be effected by an outage of particular network infrastructure elements.

IT professionals typically need to deep monitor transaction execution down to the component level to identify accurately and resolve performance issues. However, collecting and processing such data is a formidable task and typically results in too much information being presented in an unhelpful format.

Accordingly, there is a need for an improved monitoring system for monitoring execution of transactions, the applications that make up the transactions and the infrastructure elements upon which the transactions execute. There is also a need for an improved system that provides information to a system administrator in a useable format that enables the system administrator to diagnose and resolve performance issues in an effective manner.

The foregoing and other objects, aspects, features and advantages of the invention will become apparent from the following illustrative description and from the appended claims.

### SUMMARY OF THE INVENTION

The invention relates to systems and methods for monitoring distributed systems. More particularly, in one embodiment, the invention is directed to a method for monitoring a distributed application including one or more transactions on a network infrastructure. According to one aspect, the method includes: discovering a transactional path for one of the transactions; associating metrics relating to the network infrastructure with the transactional path; and providing information about the transaction to a user, based at least in part on the association between the transactional path and the metrics relating to the network infrastructure.

According to one embodiment, generating the transactional path includes identifying software components of the transaction and identifying dependencies between those components. In a further embodiment, identifying dependencies includes unpacking and analyzing files that contain the software components of the transaction. In some embodiments, the files include an Enterprise Archive (EAR) file, a Web Application Archive (WAR) file, and/or an Enterprise Java Bean (EJB) Java Archive (JAR) file. In other embodiments, identifying dependencies includes analyzing the software components of the transaction to identify direct and indirect caller relationships between the software components of the transaction. According to one feature, analyzing software components includes decompiling the software components of the transaction.

According to other embodiments, generating the transaction path includes identifying infrastructure resources that may be used by the transaction. According to one embodiment, generating the transaction path also includes identifying dependencies of software components of the transaction on the infrastructure resources that may be used by the transaction According to a further embodiment, the method of the invention includes constructing a dependency graph that identifies dependencies between the software components of the transaction and between the software components of the transaction and the infrastructure resources that may be used by the transaction.

In one embodiment, the method of the invention analyzes deployment information from the software components of the transaction to identify the dependencies of the software components on the infrastructure resources that may be used by the transaction. According to one feature, the method of the invention extracts metadata about the software components of the transaction from the deployment information. According to another feature, the method of the invention identifies dependencies of the software components on the infrastructure by unpacking and analyzing files that identify the software components of the transaction. According to one feature, the files include an Enterprise Archive (EAR) file, a Web Application Archive (WAR) file and/or an Enterprise Java Bean (EJB) Java Archive (JAR) file.

According to one embodiment, the invention relates transaction path information to metrics about the network infrastructure, such as those collected by prior art systems, to provide business relevant information about the operation of one or more transactions to the user. By way of example, according to one feature, the invention uses transaction path information to generate statistics relating to transaction execution. According to one feature, the statistics include the time a transaction takes to execute. According to a further feature, the statistics include, the maximum, minimum, mean, median and/or mode of the execution time for one or more transactions. According to another feature, the statistics include other business relevant information, such as the number of times a request for a particular transaction occurs during a defined time period.

According to a further embodiment, the invention relates the transactional path to collected metrics about the network infrastructure to provide notifications/alarms to a user in response to certain conditions being detected. For example, according to one feature, the invention notifies the user when a particular transactions takes longer than a defined threshold to execute. According to another feature, the invention notifies that execution of particular transactions may be affected in response to failures in one or more network resources typically available to those particular transactions. In this way, by determining path information, the system of the invention is able to translate technical information (e.g., a file server being down) to relevant business information (e.g., execution of a particular transaction being impacted). According to a further feature, the invention enables, the user to take corrective action, such as automatically or manually rerouting software components of a particular transaction to execute on available network resources.

In some embodiments, the invention displays an observation message to the user based on the occurrence of a condition. The message that is displayed and the condition may be user-defined.

According to another aspect, the invention is directed to a method of generating a transactional path for a distributed application, including the steps of: decomposing the distributed application into a set of software components; determining infrastructure dependencies of each software component in the set of software components; analyzing each software component in the set of software components to determine relationships to other software components in the set of software components; merging the infrastructure dependencies and the relationships into a dependency graph that represents at least one transactional path for the distributed application; and selecting a transaction path from the dependency graph.

In a further aspect, the invention is directed to a system for monitoring a distributed application including one or more transactions on a network having an infrastructure. The system includes a computer that executes programmed instructions that cause the computer to associate metrics relating to network infrastructure with a transactional path, and to provide information about a transaction to a user, based at least in part on the association between the transactional path and the metrics. In some embodiments, the programmed instructions also cause the computer to provide business relevant information about execution of the transaction to the user. In some embodiments, the programmed instructions also cause the computer to display an observation message to the user based on the occurrence of a condition.

### BRIEF DESCRIPTION OF THE DRAWINGS

The following drawings and associated descriptions, in which like reference characters generally refer to the same elements, are intended to illustrate principles of the invention.

FIG. 1 is a block diagram depicting an overview of a system for monitoring a distributed system in accordance with an illustrative embodiment of the invention.

FIG. 2 is a block diagram depicting a network infrastructure upon which a distributed application executes.

FIG. 3 is a block diagram showing interdependencies between components of a distributed application and the network infrastructure illustrated in FIG. 2.

FIG. 4 is a block diagram depicting an exemplary transactional path of the type extracted in accordance with an illustrative embodiment of the invention.

FIG. 5 is a flow diagram depicting a general method for extracting transaction path information from a distributed application according an illustrative embodiment of the invention.

FIG. 6 is a block diagram depicting an exemplary dependency graph of a type generated in accordance with an illustrative embodiment of the invention.

FIG. 7 is a flow diagram depicting a method of processing a J2EE enterprise archive file to extract transaction path information according to an illustrative embodiment of the invention.

FIG. 8 is a flow diagram depicting a method of processing a Web Archive (WAR) file to extract transaction path information according to an illustrative embodiment of the invention.

FIG. 9 is a flow diagram depicting a method of processing Enterprise Java Bean (EJB) Java Archive (JAR) files to extract transaction path information according to an illustrative embodiment of the invention.

FIGS. 10A-B show exemplary display screens depicting performance information for transaction paths according to illustrative embodiments of the invention.

FIG. 11 is a block diagram showing the structure of an observation record according to an illustrative embodiment of the invention.

FIG. 12 is an exemplary display screen depicting transaction path information with performance statistics for each software component and infrastructure element in the transaction path according to an illustrative embodiment of the invention.

FIG. 13 is an exemplary display screen for selecting a transaction path for display according to an illustrative embodiment of the invention.

### ILLUSTRATIVE DESCRIPTION

An illustrative embodiment of the invention permits a user to monitor the performance of transactional paths within a distributed application. Generally, a distributed application is a software application program that includes various software components. The components of a distributed application may execute on different computers, and may access various resources or infrastructure elements available over the network, such as databases more examples.

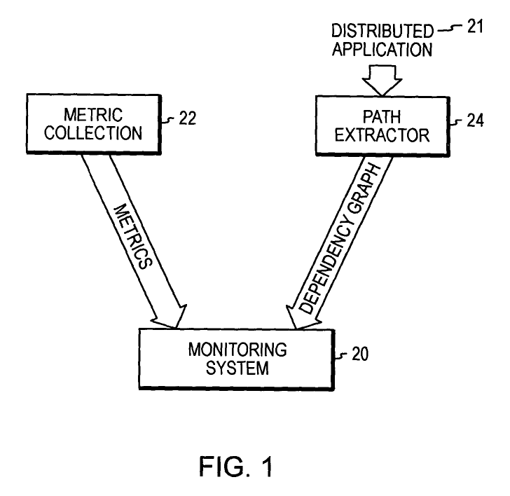

Referring now to FIG. 1, an illustrative embodiment of a monitoring system according to the invention is described in brief overview. The monitoring system 20 monitors a distributed application 21 by gathering metrics from a metric collection module 22. The metric collection module 22 is in communication with metric collectors (not shown) on various network infrastructure elements, such as servers, databases, and other network resources on which the distributed application depends. The metric collection module 22 gathers a variety of metrics from these systems, and sends them to the monitoring system 20.

The monitoring system 20 associates the metrics that are sent by the metric collection module 22 with “transaction paths” in the distributed application 21. In general terms, a transaction path is made up of all the interrelated components of the distributed application 21 that are involved in a particular transaction, such as adding an item to a shopping cart, or calculating shipping and handling charges. Once the metrics are associated with the transaction path, the monitoring system 20 can present transaction path-related performance information to users, use transaction path-related information to generate alarms, to determine the causes of errors or performance problems, and to take corrective actions. Advantageously, transaction path-related performance information generally has greater business relevance than performance metrics associated with individual servers or databases.

To generate transaction paths for the distributed application 21, the distributed application 21 is processed by a path extractor 24, which collects information about the relationships between components of the distributed application 21, and information about the dependencies of the components on various elements of a network infrastructure. These relationships and dependencies are assembled in a “dependency graph”, which contains information relating to all the relationships and dependencies in the distributed application 21. The monitoring system 20 can then select particular transaction paths from the dependency graph.

Preferably, the path extractor 24 generates the dependency graph before the monitoring system 20 is started, and save the dependency graph in a file that may be accessed by the monitoring system 20. Generally, for any given distributed application, the path extractor 24 need only be executed once, unless changes are made to the distributed application.

It should be understood that the embodiment shown in FIG. 1 is for illustrative purposes only, and that many variations are possible. For example, the metric collection module 22 may be a part of the monitoring system 20, or the monitoring system 20 may directly gather metrics.

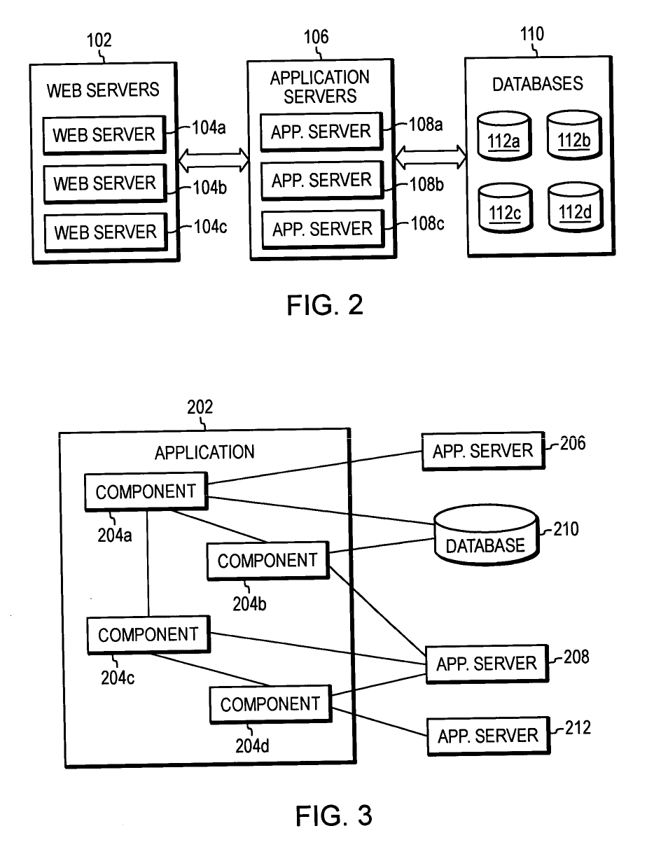

FIG. 2 shows an illustrative embodiment of a network infrastructure on which a distributed application may execute. The network infrastructure shown in FIG. 2 is particularly suited to the execution of e-commerce applications that communicate with users over a wide-area network, such as the Internet, using standard protocols, such as HTTP or other Web-related protocols. However, it should be understood that distributed applications may execute on a variety of underlying network infrastructures, and that the network infrastructure shown in FIG. 2 is for purposes of illustration only.

The network infrastructure shown in FIG. 2 includes a bank of Web servers 102, including numerous Web servers 104a-104c. The Web servers 104a-104c communicate with users over a wide-area network (not shown), such as the Internet. Generally, the Web servers 104a-104c handle communication and interaction with users using standard protocols, such as HTTP and other known Web-based protocols, languages, and data formats.

The Web servers 104a-104c may be essentially identical, and may have user interactions distributed among them in a manner intended to balance their work loads. Alternatively, one or more of the Web servers 104a-104c may be configured differently from the others, to provide users with access to services that are not accessed through the others. The Web servers 104a-104c may each execute on different computers, or two or more of them may execute on the same computer.

The Web servers 104a-104c in the bank of Web servers 102 communicate with a bank of application servers 106. The bank of application servers 106 includes numerous application servers 108a-108c. The application servers 108a-108c generally handle the core application functions or business logic of a distributed application. Typically, components of a distributed application that handle core functions or business logic execute on the application servers 108a-108c.

The application servers 108a-108c in the bank of application servers 106 may be configured so that each application server executes particular components of the distributed application. Alternatively, the components may be distributed among one or more of the application servers 108a-108c in a manner intended to balance the work loads of the application servers. The application servers 108a-108c may execute on different computers, or two or more of the application servers may execute on a single computer.

Some of the application servers 108a-108c need to access databases to complete their tasks. These application servers communicate over a network with databases in a bank of databases 110. The bank of databases 110 includes numerous databases 112a-112d. Generally, the databases 112a-112d are resources that are accessed by components of a distributed application.

As with other elements of the network infrastructure, the databases 112a-112d may reside on numerous computers, or two or more databases may be combined on a single computer.

The Web servers 104a-104c, the application servers 108a-108c, and the databases 112a-112d, as well as any other servers, databases or items that make up a network infrastructure are referred to herein as elements of a network infrastructure, or as resources. Generally, each element of a network infrastructure may be monitored to collect various metrics relating to the performance of that element. For Web servers, the metrics collected may include, for example, information on the number of requests received in a period of time, the response time of the Web server, the throughput of the Web server, and other statistics relevant to Web servers. For application servers, the metrics may include, for example, the number of sessions, the number of components running on the server, statistics on each of the components (e.g. number of requests, response time, etc.), and other metrics relevant to an application server. Metrics collected relating to databases may include, for example, database size, number of statistics on particular tables in the database, statistics on accesses to the database, and other metrics relevant to a database. Metrics relating to the underlying hardware, such as CPU usage statistics, memory usage statistics, disk space usage statistics, network performance statistics, and other hardware and system related metrics may also be collected from any of the elements of the network infrastructure.

As mentioned above, many different configurations are possible for a network infrastructure. For example, some network infrastructures may include elements that are not described above, such as directory servers, mail servers, chat servers, and so on. The presence of such elements in a network infrastructure depends on the applications that execute on the network infrastructure. Other configurations, in which, for example, the Web servers directly access databases, are also possible.

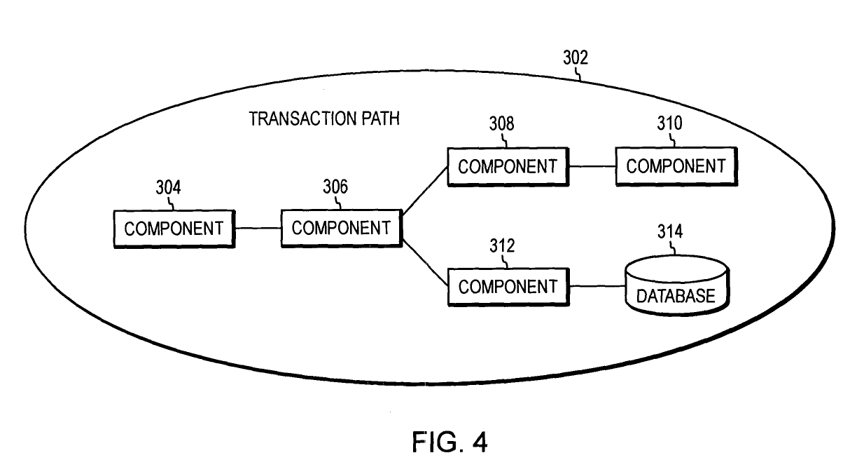

FIG. 3 shows an example of interdependencies between components of a distributed application and illustrative network infrastructure resources. As can be seen, a distributed application 202 includes numerous software components 204a-204d. The components 204a-204d each perform a specific task, and may be interrelated, as shown in FIG. 3. For example, in FIG. 3, the component 204a has a relationship with components 204b and 204c. The relationships between the components 204a-204d typically represent caller-callee relationships.

In addition to having relationships between the software components, each of the components 204a-204d has dependencies on one or more network infrastructure resources. These resources illustrated in FIG. 3 include the application servers 206 and 208, the database 210, and the Web server 212. Thus, for example, the component 204a depends on the application server 206, and the database 210. The nature of these dependencies varies. For example, the dependency of the component 204a on the application server 206 indicates that the component 204a is able to run on the application server 206, while the dependency on the database 210 indicates that the component 204a accesses data in the database 210.

It should be noted that the structure of the distributed application 202 shown in FIG. 3 is for illustrative purposes only. A typical distributed application may include dozens (or hundreds) of components, with many interrelations between components and dependencies on network infrastructure elements.

Distributed applications perform functions that are referred to as transactions. Generally, a transaction is a series of steps that may be built by a distributed application for taking a particular action. When the transaction is “committed”, the series of steps is executed. Examples of transactions in a typical e-commerce distributed application include, for example, adding an item to a shopping cart, removing an item from a shopping cart, searching for an item, providing payment information, providing shipping information, determining shipping costs, filling out electronic forms and starting a new order.

A typical transaction may involve numerous components of a distributed application, which may depend on numerous elements of the network infrastructure. The path through the set of components and infrastructure elements that is involved in performing a particular transaction is referred to herein as a transaction path.

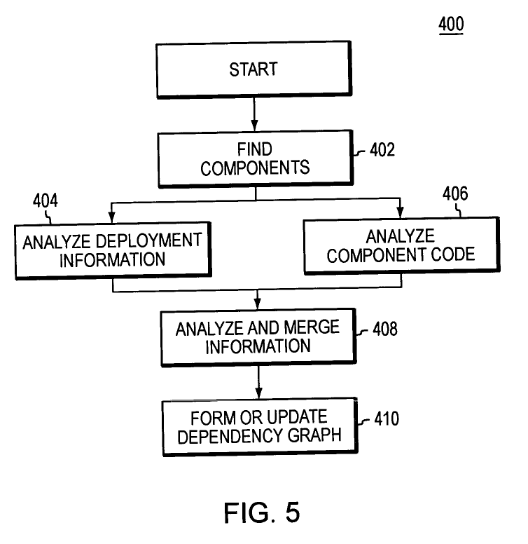

FIG. 4 shows an illustrative example of such a transaction path 302. The transaction path 302 includes components 304, 306, 308, 310, 312, and a database 314. Note that while the dependency on the database 314 is shown in the transaction path 302, for purpose of illustration, dependencies on various application servers and Web servers are not shown. This does not indicate that such dependencies are not present.

A distributed application may include numerous transactions. Likewise, the transaction path of each of the transactions may include numerous components. Any given component in a distributed application may be part of numerous transaction paths. Similarly, a particular network infrastructure element, such as a database, may be part of numerous transaction paths.

While the transaction paths are usually inherently present in the design of a distributed application, they usually are not explicitly designated in the code for the application. Thus, to display or use the transaction paths of a distributed application, it is first necessary to find the transaction paths that are present in the application.

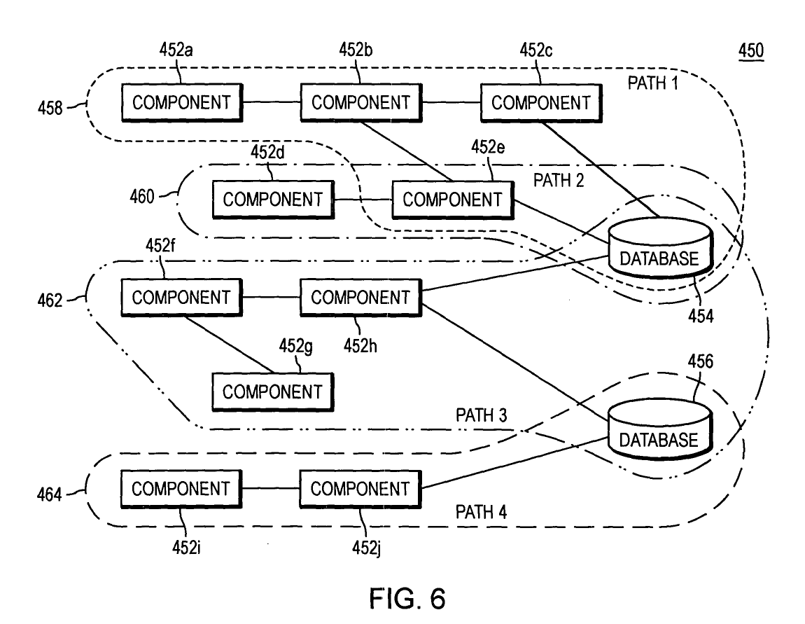

FIG. 5 shows a flowchart of a general procedure 400 for finding the transaction paths in a distributed application according to an illustrative embodiment of the invention. First, in step 402, the procedure 400 finds each component in the application. This involves, for example, unpacking archives or other files that contain the various components that are part of the distributed application.

Typically, the code for a distributed application includes deployment information that specifies, for example, the servers on which a particular component may execute. This deployment information is useful for determining the dependencies of components on network infrastructure elements. In step 404, procedure 400 locates the deployment information and analyzes it to determine these dependencies. Through analysis of the deployment information, the procedure 400 may also identify relationships between components.

Typically, the deployment information associated with a distributed application includes explicit information on dependencies of components on resources, and limited explicit information on relationships (such as part-whole relationships) between components. Where such explicit information is present, step 404 parses the deployment information to gather the relationship and dependency information.

The deployment information also typically contains metadata that describes the characteristics, attributes, and classification of the components. The metadata may include information such as the name of a component, its size, its author, and other information relating to a component. Step 404 also extracts this metadata for each component.

In step 406, the procedure 400 analyzes the components themselves to identify relationships between components. According to the illustrative embodiment, this involves analyzing the code for the components to discover direct and indirect caller-callee relationships between the components. A direct caller-callee relationship exists, for example, when a method on a class is invoked via a virtual or static method call. An indirect caller-callee relationship exists, for example, when there is an indirect call through an intermediate class.

The analysis of step 406 may be performed by examining the code for a component to find calls to particular application program interfaces (APIs) that are known to be associated with building a transaction. If the code for the component is object code, an intermediate form, or an executable, it may be necessary to “decompile” the code, to place the code into a form that may be searched for API or method calls. Decompiling the code may be performed by a variety of known decompilation techniques and tools. For example, the Byte Code Engineering Library (BCEL), available from the Apache Software Foundation, may be used to effectively “decompile” Java byte codes into a form that permits the analysis of step 406 to be performed.

Next, in step 408, the process 400 analyzes and merges the results of steps 404 and 406. In accordance with the illustrative embodiment, it is possible for both the analysis of the code, in step 406, and the analysis of the deployment information, in step 404, to reveal relationships for the same components. Similarly, the metadata and resource dependency information identified by analyzing the deployment information in step 404 may be associated with components for which relationships are identified through analysis of the code in step 406.

Finally, in step 410, the process 400 uses the merged information from step 408 to form or update a dependency graph for the application. According to the illustrative embodiment, the dependency graph for a distributed application includes all of the transaction paths of the distributed application. The nodes in the graph represent components or resources, and the edges of the graph represent relationships between components or dependency of components on resources. The metadata that is extracted in step 404 is associated with the nodes of the graph. Once this dependency graph is formed, any transaction path in the application can be found in the dependency graph.

It should be recognized that there may be other general methods for identifying the transaction paths in a distributed application. For example, information in the transaction paths may be derived by analyzing the communications between the various network infrastructure elements, or the event streams between components. The patterns that emerge from this analysis may indicate the transaction paths in the distributed application without requiring access to the code for the distributed application.

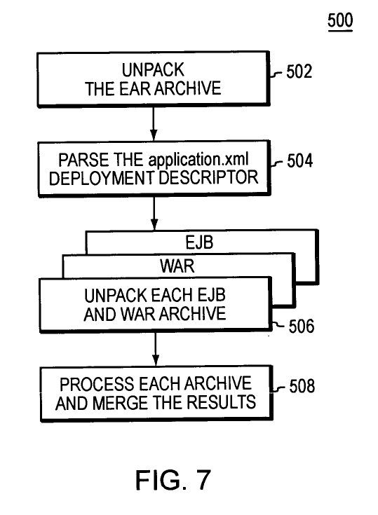

An example dependency graph is shown in FIG. 6. The dependency graph 450 includes components 452a-452j, each of which is a component of the distributed application, and each of which may include metadata. Typically, the edges between the components 452a-452j represent caller-callee relationships, but they may also represent other relationships, such as part-whole relationships, or other relationships between software components.

The dependency graph 450 also identifies network resources, including a database 454 and a database 456. The edges between various ones of the components 452a-452j and the databases 454 and 456 generally indicate a dependency between the component and the database.

There are several transaction paths in the dependency graph 450, that include overlapping/common ones of the components 452a-452j and the databases 454 and 456. For example, a first transaction path 458 includes the components 452a, 452b, 452c, and 452e, and the database 454. A second transaction path 460 includes the components 452d and 452e, and the database 454. A third transaction path 462 includes the components 452f, 452g, and 452h, and the databases 454 and 456. A fourth transaction path 464 includes components 452i and 452j, and database 456.

It is possible to select a transaction path from the dependency graph 450 by specifying a starting point for the transaction path, and following the relationships and dependencies from that starting point. For example, the component 452f is the starting point for the third transaction path 462.

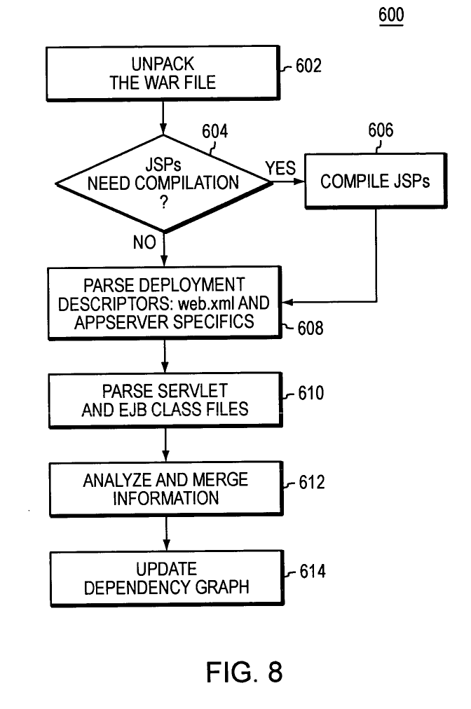

FIG. 7 shows a flow chart of an illustrative embodiment of a transaction path discovery process 500 for use with J2EE (Java 2 Platform, Enterprise Edition) Enterprise Archive (EAR) files that contain information on a distributed application. The description of the J2EE embodiments provided herein with reference to FIGS. 7-9 assumes a familiarity with the well-known J2EE platform. Background information on the J2EE platform can be found in “The Java 2 Platform Enterprise Edition Specification, v. 1.3”, available from Sun Microsystems, Inc. of Palo Alto, Calif., and available on the Web at “java.sun.com/j2ee/docs.html”.

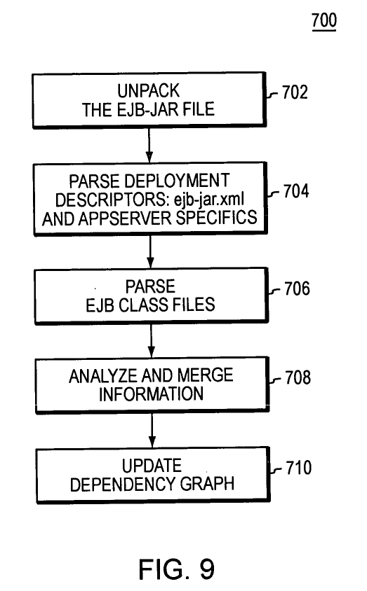

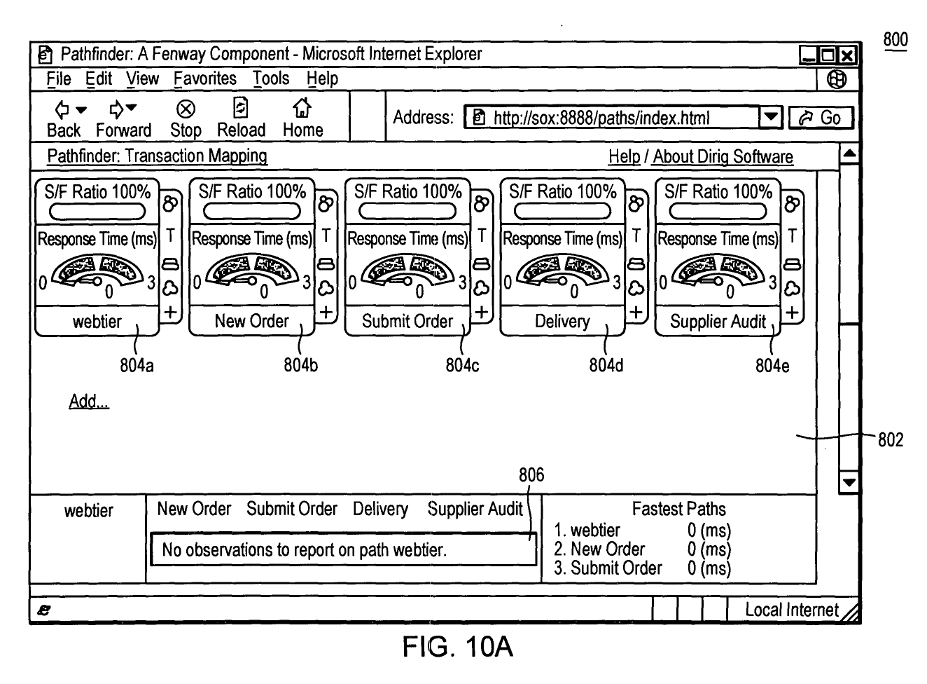

First, in step 502, the process 500 unpacks the EAR archive file. Generally, an EAR archive contains a deployment descriptor, named “application.xml”, and a set of embedded archive files, which are typically Enterprise JavaBean (EJB) Java Archive (JAR) files, or Web Application Archive (WAR) files. These embedded archive files contain the components, and procedures for handling them are detailed below, with reference to FIGS. 8 and 9.

Next, in step 504 the process 500 parses the deployment descriptor stored in the “application.xml” file to determine the dependencies and metadata stored in the “anplication.xml” file.

In step 506, the process 500 unpacks each of the WAR and EJB-JAR archives that are part of the EAR archive. In step 508, each of these WAR and EJB-JAR archives is processed, as shown in FIGS. 8 and 9, and the results are merged to form a dependency graph for the distributed application.

Once the dependency graph is fully formed, it has as nodes all of the components of the distributed application, which may include all of the J2EE components, EJBs, EJB transactional methods, servlets, and JSPs. The graph also has as nodes certain resources (i.e., network infrastructure elements), such as databases, upon which the components depend. The graph also includes metadata associated with the nodes of the graph, containing information on the components and resources. This metadata may also include information regarding certain dependencies of the components on network infrastructure elements, such as specific application servers. The graph also includes edges between the nodes, representing the relationships and dependencies between the components and resources in the graph. These edges may include information on the type of relationship represented by the edge.

When this dependency graph is complete, it may be written to a file for later use in monitoring systems. According to one illustrative embodiment, this file uses a standard format, such as XML, so that it may be read by a variety of tools. Alternatively, the file may be written in a proprietary format, permitting easy access to the dependency graph, and the transaction path information only to monitoring systems provided by particular vendors.

Referring now to FIG. 8, a process 600 for parsing and analyzing WAR archive files according to an illustrative embodiment of the invention is described. The process 600 may be integrated with the process 500 described with reference to FIG. 7, or may be a separate process.

In step 602, the process 600 unpacks the WAR archive. Typically, a WAR archive includes a deployment descriptor file named “web.xml”, Java Servlets, and Java Server Page (JSP) files. EJB class files may also be present in the WAR archive. If this process is integrated with the process of FIG. 7, this step may not be necessary, since the WAR archive files were unpacked in step 506.

Before the code in the JSP files is analyzed, it is compiled into Java Servlets. Thus, if the WAR archive contains any JSP files that require compilation (step 604), in step 606, the process 600 compiles the JSP files into Java Servlet source files. These source files are subsequently compiled into Java Servlet class files, which contain the static bytecodes for the servlet that was compiled from the JSP file. These bytecodes are of the form that is typically analyzed by the system (which may involve a partial “decompilation”, as discussed above).

Next, in step 608, the process 600 parses and analyzes deployment information stored in the “web.xml” file, and in application server-specific Web application deployment descriptors. These Web application deployment descriptors are typically generated by tools or products that are used to create J2EE archive files, such as BEA Weblogic or IBM WebSphere. Alternatively, such deployment descriptors may be manually generated, and placed in a J2EE archive.

The “web.xml” file is searched for servlet and JSP entities. As these entities are found, the data structure representing the dependency graph is updated to include them. Processing the application server-specific Web application deployment descriptors provides information about resource dependencies and a mapping to application server deployment information for each resource dependency.

Next, in step 610, the process 600 analyzes the static byte codes to find relationships between components (which, in J2EE, may be EJBs, servlets, EJB transactional methods, J2EE components, and/or JSPs). Static bytecodes are analyzed for all EJB class byte code files, all servlet byte code files (including those compiled from JSP files), and all regular Java class files embedded in or referenced by the J2EE application.

The process 600 analyzes the byte codes for direct and indirect caller-callee relationships, and for resource dependencies that are not evident from the deployment descriptors that were analyzed in step 608. By performing this analysis, various relationships are discovered, including, but not limited to relationships of EJBs to other EJBs, relationships of EJB transactional methods to EJBs, relationships of EJB transactional methods to EJB transactional methods, relationships of servlets to EJBs, and relationships of servlets to EJB transactional methods.

Next, in step 612, the information gathered in steps 608 and 610 is analyzed and merged, as discussed above with reference to FIG. 5. In step 614, the dependency graph for the distributed application is updated to include the various entities, relationships, and dependencies that were discovered by processing the WAR file.

Referring now to FIG. 9, a process 700 for parsing and analyzing EJB-JAR archive files according to an illustrative embodiment of the invention is described. The process 700 may be integrated with the process 500 described with reference to FIG. 7, or may be a separate process.

In step 702, the process 700 unpacks the EJB-JAR archive file. Typically, an EJB-JAR archive file includes a deployment descriptor file named “ejbjar.xml”, and EJB class files. If the process 700 is integrated with the process 500 of FIG. 7, this step may not be necessary, since the WAR archive files are unpacked in step 506.

Next, in step 704, the process 700 parses and analyzes deployment information stored in the “ejb-jar.xml” file, and in application server-specific deployment files. The deployment descriptor analysis of step 704 finds metadata for each EJB in the archive. This metadata typically contains EJB implementation information, as well as transactional method declarations and resource dependency declarations.

For each EJB, an entity is created in the dependency graph. Transactional methods may be added to the dependency as sub-entities under the EJB entity of which they are a part (i.e., there is a part-whole relationship between the transactional methods and an EJB).

Resource dependencies are identified for EJBs, and for the transactional methods. Additionally, processing the application server-specific deployment files may provide information about resource dependencies and a mapping to application server deployment information for the resource dependencies.

Step 704 finds the names of three special classes that represent an EJB: the Home and LocalHome classes, the Remote and Local classes, and the Implementation class. The relationship analysis performed in step 706 employs special handling of method calls to the Home and Remote class interfaces of an EJB by other components.

Generally, there are two kinds of methods in an EJB: normal methods which do not generate an EJB transaction or will never directly generate one (they may indirectly generate an EJB transaction by calling a transactional method), and methods that are transactional or that are candidates for being transactional. Such transactional methods may affect the transactional state of a computational process of an EJB application. The process 700 typically analyzes those transactional methods declared inside deployment descriptors for EJBs. The methods of the Home, LocalHome, Remote and Local EJB interfaces are candidates for declarative transactions.

Next, in step 706, the process 700 analyzes the EJB class files, which contain static byte codes, to identify relationships between components. Additionally, the process may analyze regular Java class files embedded in or referenced by the J2EE application.

As noted above, step 706 provides special handling of method calls to the Home and Remote class interfaces on an EJB. This special handling involves processing each method from the Home, LocalHome, Remote and Local EJB interfaces, and matching against the declared transactions to determine if a particular method is involved in a J2EE transaction. Generally, a method is involved in a J2EE transaction by creation of a new transaction if one is not present, supporting an existing one, requiring a new one being created, not supporting transactions, etc.

Once it is discovered that a method is transactional, the method is mapped to a method in the EJB implementation class. The Home, LocalHome, Remote and Local interfaces mark interfaces supported by an EJB or its remoting mechanism classes, and therefore use such a mapping. If the method is transactional, then the method is included in the dependency structure output.

The process 700 also analyzes the byte codes to identify direct and indirect caller-callee relationships, and to identify resource dependencies that are not evident from the deployment descriptors that are analyzed in step 704. By performing this analysis, various relationships are identified, including, but not limited to relationships of EJBs to other EJBs, relationships of EJB transactional methods to EJBs, and relationships of EJB transactional methods to other EJB transactional methods.

Next, in step 708, the information gathered in steps 704 and 706 is analyzed and merged, as discussed above, with reference to FIG. 5. In step 710, the process 700 updates the dependency graph for the distributed application to include the various entities, relationships, and dependencies identified by processing the EJB-JAR archive.

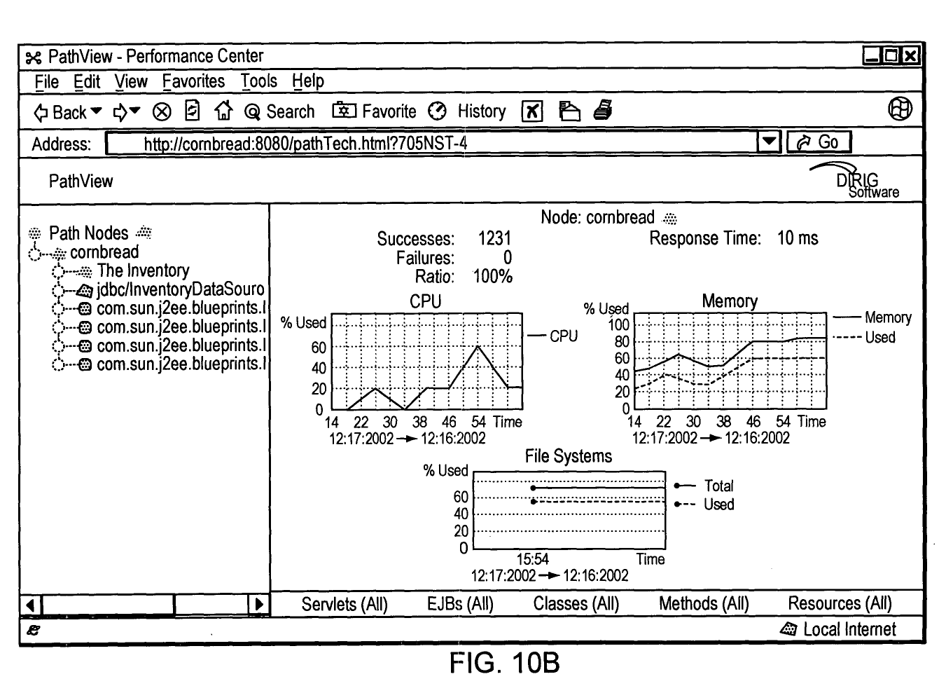

FIG. 10A shows a display screen 800 for a monitoring system that uses transaction paths to monitor the performance of a distributed application according to an illustrative embodiment of the invention. The display screen 802 includes performance meters 804a-804e, each of which depicts an immediate, easy-to-read indication of the performance of a transaction path in the distributed application. In the example shown in FIG. 10A, each of the meters 804a-804e shows an indication of the response time for a transaction path.

The display of numerous meters, such as is shown in screen 802, permits a user to quickly asses the performance of numerous transaction paths in an application. Advantageously, these transaction path-related performance indicators are easier to understand, and often have greater immediate business relevance than metrics associated with individual elements of a network infrastructure. The business relevance of the transaction path-related metrics may be emphasized by associating a financial value to transactions, for example, by determining and/or displaying the cost of failures or poor performance.

To derive these transaction path-based performance indicators, the illustrative system of the invention collects metrics from the various network infrastructure elements. These metrics are collected using known metric collection techniques, and include a variety of statistics and performance indications for the various network infrastructure elements in a system, as described above with reference to FIG. 2.

According to a further illustrative feature, the system of the invention associates the collected metrics with the nodes along a transaction path using the dependencies between the nodes (i.e., components and certain resources) in a transaction path and elements of the network infrastructure, as determined by the above-described illustrative processes of FIGS. 5 and 7-9. Once this association is made, the illustrative system of the invention combines the collected metrics for the individual nodes of the transaction path to compute an overall metric for the entire transaction path. This overall metric may then be displayed in a variety of formats, including the meter format that is shown in FIG. 10A.

In addition to being displayed, a metric or performance indicator associated with a transaction path may be used for a variety of purposes, such as providing method call count, timing, or exceptional case data that is associated with a unique path of a transactional flow. Generally, the illustrative system uses transaction path-related metrics or performance indicators in a manner similar to that in which other metrics or performance indicators may be used.

Thus, a transaction path-related metric or performance indicator can trigger the system to raise an alarm if the metric or performance indicator falls outside of a “normal” range (determined by thresholds), or if a problem is identified in the transaction path. An alarm or “observation” may also be raised if the performance of particular nodes of a transaction path varies too much from the performance of selected “baseline” nodes in the application.

In addition to raising alarms, the system collects and stores historical data on the transaction path-related metrics, which can later be used for analysis purposes. As will be described below, the system can also use the transaction path-related metrics or performance indicators to help determine the cause of problems, to determine which transactions will be affected by a problem in the system, and to assist in taking remedial actions.

In addition to showing performance meters 804a-804e, screen 802 includes an observations area 806. For each of the transaction paths for which performance indicators or metrics are shown on screen 802, the illustrative system generates warning messages and observations of abnormal behavior. These warnings and observations are displayed in the observations area 806.

These warnings or observations may be generated in a similar manner to the generation of alarms. For example, a warning may be generated if a transaction path-related metric or performance indicator falls outside of thresholds. Additionally, observations may be based on performance of a node varying from a “baseline” performance, as discussed above. Observations may also be based on application of predefined or user-defined rules to metrics.

In FIG. 10B, information on metrics is presented in the format of a graph, that shows current metric values, as well as information on past values of the metrics being displayed in graphs. Other known display methods may also be used to display present and past values of metrics.

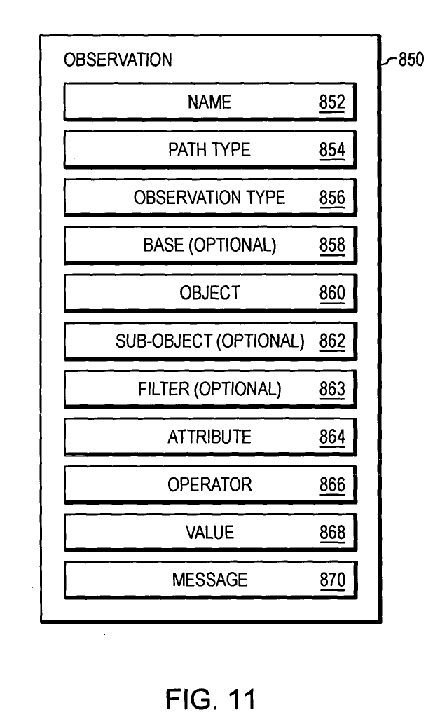

Referring to FIG. 11, an illustrative structure for an observation record is described. An observation structure 850 is used to specify observations that are to be tracked by the system. The observation structure 850 defines an the parameters of an observation that, if violated, will cause a message to be displayed in the observation area 806.

The observation structure 850 includes a name field 852, in which a user may specify a unique name for use in identifying an observation.

A path type field 854 is used to restrict an observation to specified types of paths. In the illustrative embodiment, there are four general path types that may appear in the path type field 854. The “all” path type specifies that the observation is run against all types of paths. The “database” path type specifies that the observation is run against database paths (i.e., paths that map database elements, such as space utilization and throughput). The “transaction” path type specifies that the observation is run against paths that map transactions within application server components, such as servlets, EJBs, custom classes, and connection pools. The “Web” path type specifies that the observation is run against paths that relate Web server elements, such as network and server throughput and remote response times.

An observation type field 856 is used to configure the type of matching or comparison that is used with a particular observation. For example, a metric such as servlet response time could be compared against the average of the servlet response times for all servlets, a specific value, or against the servlet response time on a particular node.

In one illustrative embodiment of the invention, there are three general observation types that may be used in the observation type field 856. An “individual” observation type is used to specify that data is to be compared directly to a set value. An “average” observation type is used to specify that data is to be compared to the average of the data points of the same sort on all nodes. A “baseline” observation type specifies that data is to be compared to a baseline value established on a specific node. If the observation type is “baseline”, then an optional base field 858 is used to specify the name of the node that will be used to establish the baseline value.

An object field 860 specifies which elements are to be compared. The object field 860 can be set to “path” to compare statistics across paths, “node” to compare statistics for nodes within a path, or “point” to compare specific data points within a path. If the object field 860 is set to “point”, then an optional sub-object field 862 is used to specify the sub-object type for which the observation should monitor and compare data. Examples of sub-object types include: all points (i.e., all data points in a path), application data, servlets, servlet methods, any EJB, EJB session beans, EJB entity beans, EJB message-driven beans, EJB methods, user classes (i.e., anything that is not a servlet or EJB), user class methods, application server resources, throughput for web server or database paths, space utilization for database paths, and remote response times.

An optional filter field 863 may be used with “point” objects to limit comparison of sub-objects to those with a specified name. A regular expression, including wildcard characters, may be used to specify names of sub-objects. For example, the sub-object field 862 and filter field 863 may be used to specify that EJB message-driven beans with the name “TheShoppingClientController” are to be monitored by the observation.

An attribute field 864 specifies which data point to use when making comparisons. For “path” or “point” objects, the attribute field 864 may contain “success”, indicating the successful processing of the data point, “failure”, indicating a failed result during an operation, or “response time”, indicating the amount of time (typically in milliseconds) for the data point process to either succeed or fail. For “node” objects, these three choices may be used in the attribute field 864, as well as other attributes, including: “CPU”, indicating the amount of CPU being utilized on the node; “memory”, indicating the amount of memory being utilized on the node; “swap”, indicating the amount of swap capacity being utilized on the node; “health”, indicating an overall health rating for the node, and other user-defined statistics, or statistics that depend on the path type. For example, for database paths, useful statistics may include cache hit ratios.

An operator field 866 specifies the operator that will be used to make a comparison. The operator field 866 may contain “greater than”, “less than”, “equal”, “not equal”, “percent greater”, “percent less”, “delta increase”, or “delta decrease”. The “greater than” operator causes a value above a defined value to trigger the observation. Similarly, the “less than”, “equal”, and “not equal” operators cause the observation to trigger when a value of a metric is less than, equal, or not equal to a defined value, respectively. When using the “percent greater” or “percent less” operators, the observation will be triggered when the value is a user specified percent above or below an initial value. The “delta increase” and “delta decrease” operators specify that the observation should trigger if the value increases or decreases from an initial value beyond a specified amount.

A value field 868 defines a value that is used with the operator that is specified in the operator field 866. For example, for the “percent greater” or “percent less” operators, the value field 868 would contain the actual percentage to be used.

A message field 870 specifies the message that is to be displayed in the observations area 806 when the observation is triggered. In some embodiments, the system may use text substitution to display on which path or node an observation is occurring, or to display the value that triggered the observation.

Using a structure such as the observation structure 850, users may define a variety of observations to be displayed when specified events occur. Additionally, a system in accordance with some embodiments of the invention includes numerous predefined observations. For example, the following table shows the name, path type, object type, and description for numerous pre-defined observations that are used in one embodiment of the invention:

| Name | Path type | Object | Description |
|---|---|---|---|
| Excessive CPU | All | Node | CPU utilization |
| Excessive Mem | All | Node | Memory utilization |
| Excessive Swap | All | Node | Swap utilization |
| Poor Health | All | Node | The number and severity of |
| | | | alerts |
| JVM Heap Util | Transaction | Node | JVM (Java Virtual Machine) |
| | | | heap utilization |
| Conn Pool Util | Transaction | Node | Connection pool utilizations |
| AppSrv Thruput | Transaction | Node | Application server throughput |
| Servlet Rsp Time | Transaction | Point | Servlet response time |
| EJB Rsp Time | Transaction | Point | EJB response time |
| Server Busy | Web | Node | Percent of the time that the |
| | | | server is busy |
| Process Count | Web | Point | Number of spawned web |
| | | | processes |
| Web Thruput | Web | Point | BytesIn/BytesOut of web |
| | | | server |
| Web Response | Web | Point | Response time to web server |
| Space Diff | Database | Point | Distributed database capacity |
| Perf Ratio | Database | Point | Performance ratio comparison |

It should be understood that the table lists only a few pre-defined observations. Some illustrative embodiments of the invention may include hundreds of such pre-defined observations, and may handle numerous user-defined observations.

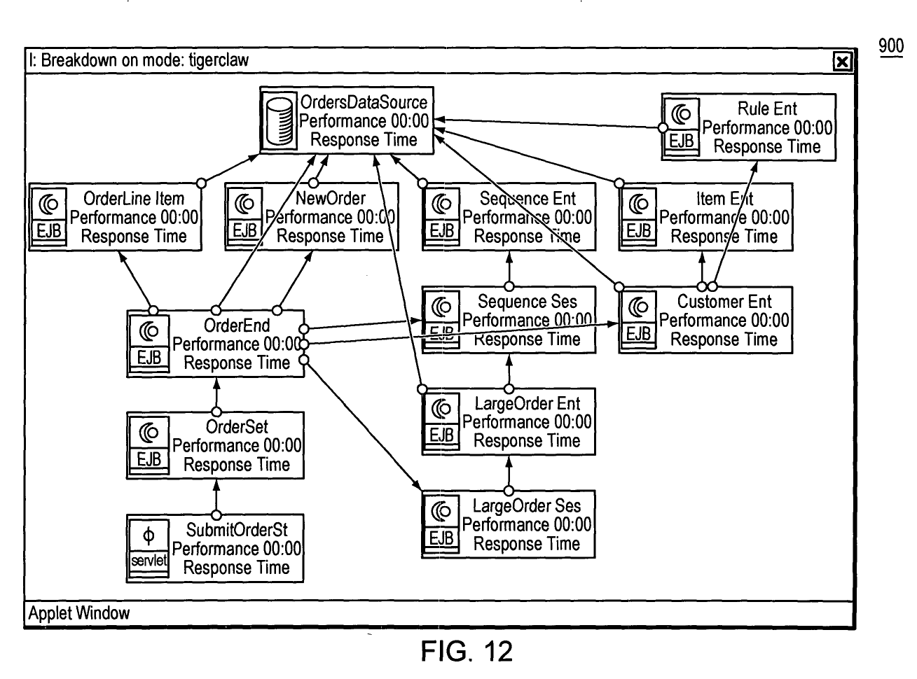

In addition to showing the metrics or performance indicators for an overall transaction path, the system can also display a transaction path, and show metrics associated with each particular node of a transaction path. FIG. 12 shows a transaction path with components and resources, and performance statistics or metrics on each such component or resource according to an illustrative embodiment of the invention.

A display such as is shown in FIG. 12 may be used for a variety of purposes. For example, when an alarm is raised, information about the performance of the components in a transaction path may be used to determine which components or resources are causing the problem. Thus, an examination of the metrics associated with the components or resources in a transaction path may be used to determine where the points of failure are located, and to determine the cause of a failure or other abnormal condition. Without having the information on transaction paths that is extracted by the system, it would be more difficult to associate the failure or poor performance of a transaction with a particular component or network infrastructure element.

Additionally, by determining which components or resources are causing failures, it is possible to determine which transactions will be affected by a particular failure or performance problem. When such problems occur, the illustrative system may be able to take remedial measures, such as running a particular component on a different application server, changing the resources upon which a component depends, or re-routing transaction paths.

As with the metrics collected about entire transaction paths, the metrics collected about components and resources in a transaction path are typically stored by the system as historical data. Such historical data can be used for later analysis, or for other purposes, such as determining a “baseline” performance for components.

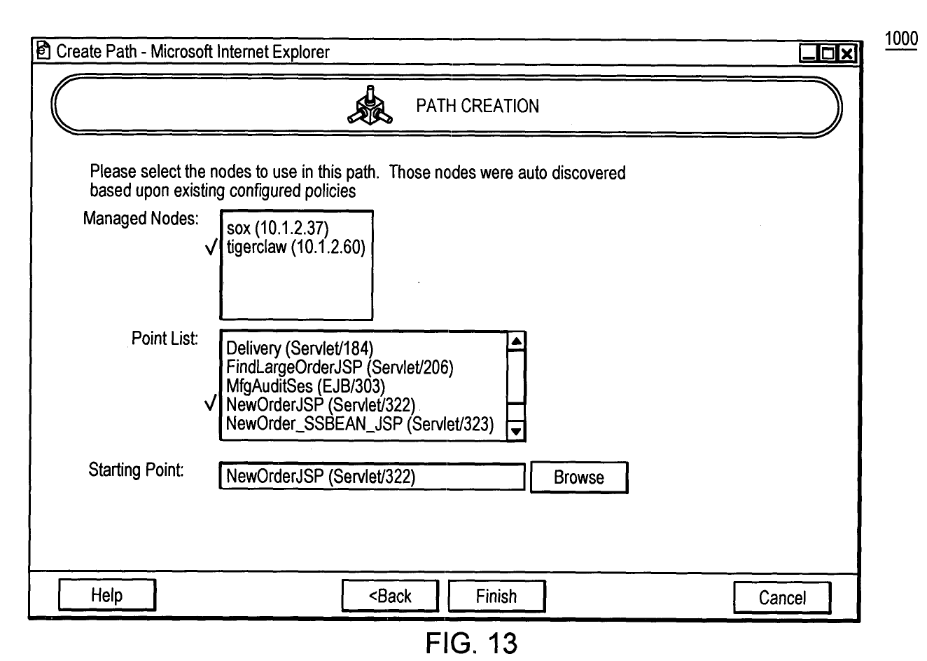

FIG. 13 shows a display screen 1000 that permits a user to select a particular transactions path on a particular node of a network for display. The transaction paths that may be selected are based on the transaction paths identified by the above-described illustrative processes of FIG. 5 or 7-9, and are designated by “starting points”, which represent a component in the distributed application which serves as the starting point of a transaction path. Once the starting point has been selected, a transaction path associated with that starting point can be extracted from the dependency graph by following the relationships of the starting point in the dependency graph. As described above, once transaction paths are selected, they can be used to monitor the performance of a distributed application.

In this way, the invention attains the objects set forth above and provides systems and methods for monitoring distributed applications by, in one embodiment, generating a transactional path and associating metrics relating to software components and network elements to the transactional path to provide business relevant information to a user.

Changes may be made in the above constructions and foregoing sequences of operation without departing from the scope of the invention. Fore example, the transactional path determination features may be employed alone or as integrated components with a system for determining particular metrics to be associated with the identified transactional paths. Also, the above described invention may be embodied in hardware, firmware, object code, software or any combination of the foregoing. Additionally, the invention may include any computer readable medium for storing he methodology of the invention in any computer executable form.

It is accordingly intended that all matter contained in the above description or shown in the accompanying drawings be interpreted as illustrative rather than in a limiting sense.

What is claimed is:

1. A method of monitoring a distributed application including one or more transactions on a network having an infrastructure, the method comprising:
generating a transactional path for one of the transactions,
associating metrics relating to the network infrastructure with the transactional path, and
providing information about the transaction to a user, based at least in part on the association between the transactional path and the metrics relating to the network infrastructure.

2. The method of claim 1, wherein the generating step comprises identifying software components of the transaction.

3. The method of claim 2, wherein the generating step comprises identifying dependencies between the software components of the transaction.

4. The method of claim 3, wherein the identifying dependencies step comprises unpacking and analyzing files that identify the software components of the transaction.

5. The method of claim 4, wherein the files include an Enterprise Archive (EAR) file.

6. The method of claim 4, wherein the files include a Web Application Archive (WAR) file.

7. The method of claim 4, wherein the files include an Enterprise Java Bean (EJB) Java Archive (JAR) file.

8. The method of claim 3, wherein the identifying dependencies step comprises analyzing the software components of the transaction to identify direct and indirect caller relationships between the software components of the transaction.

9. The method of claim 8, wherein the analyzing software components step comprises decompiling the software components of the transaction.

10. The method of claim 1, wherein the generating step comprises identifying infrastructure resources that may be used by the transaction.

11. The method of claim 10, wherein the generating step comprises identifying dependencies of software components of the transaction on the infrastructure resources that may be used by the transaction.

12. The method of claim 11, wherein the generating step comprises identifying dependencies between the software components of the transaction.

13. The method of claim 12, wherein the generating step comprises constructing a dependency graph that identifies dependencies between the software components of the transaction and between the software components of the transaction and the infrastructure resources that may be used by the transaction.

14. The method of claim 11, wherein the generating step comprises using deployment information from the software components of the transaction to identify the dependencies of the software components on the infrastructure resources that may be used by the transaction.

15. The method of claim 14, wherein the generating step comprises extracting metadata about the software components of the transaction from deployment information.

16. The method of claim 11, wherein the identifying dependencies step comprises unpacking and analyzing files that identify the software components of the transaction.

17. The method of claim 16, wherein the files include an Enterprise Archive (EAR) file.

18. The method of claim 16, wherein the files include a Web Application Archive (WAR) file.

19. The method of claim 16, wherein the files include an Enterprise Java Bean (EJB) Java Archive (JAR) file.

20. The method of claim 1, wherein the providing information step comprises providing business relevant information about execution of the transaction to the user.

21. The method of claim 20, wherein the business relevant information includes a notification of the transaction taking more than a threshold time to execute.

22. The method of claim 20, wherein the business relevant information includes notification of infrastructure resources that may be used by the transaction being unavailable.

23. The method of claim 22, wherein the business relevant information includes notification of how unavailability of ones of the infrastructure resources that may be used by the transaction may effect performance of the transaction.

24. The method of claim 20, wherein the business relevant information includes which of the one or more transactions may be effected by unavailability of ones of the infrastructure resources that may be used by the one or more transactions.

25. The method of claim 1, wherein the providing information step comprises displaying an observation message to the user based on the occurrence of a condition.

26. The method of claim 25, wherein the observation message is user-defined.

27. The method of claim 25, wherein the condition is user-defined.

28. A method of generating a transactional path for a distributed application, the method comprising:
decomposing the distributed application into a set of software components;
determining infrastructure dependencies of each software component in the set of software components;
analyzing each software component in the set of software components to determine relationships to other software components in the set of software components;
merging the infrastructure dependencies and the relationships into a dependency graph that represents at least one transactional path for the distributed application; and
selecting a transaction path from the dependency graph.

29. The method of claim 28, wherein the determining infrastructure dependencies step comprises using deployment information from the software components to identify the infrastructure dependencies of the software components.

30. The method of claim 29, wherein the determining infrastructure dependencies step comprises extracting metadata about the software components from the deployment information.

31. The method of claim 28, wherein the decomposing step comprises unpacking and analyzing files that identify the software components.

32. The method of claim 31, wherein the files include an Enterprise Archive (EAR) file.

33. The method of claim 31, wherein the files include a Web Application Archive (WAR) file.

34. The method of claim 31, wherein the files include an Enterprise Java Bean (EJB) Java Archive (JAR) file.

35. A system for monitoring a distributed application including one or more transactions on a network having an infrastructure, the system comprising:
A computer that executes programmed instructions that cause the computer to associate metrics relating to network infrastructure with a transactional path, and to provide information about a transaction to a user, based at least in part on the association between the transactional path and the metrics.

36. The system of claim 35, wherein the programmed instructions further cause the computer to provide business relevant information about execution of the transaction to the user.

37. The system if claim 35, wherein the programmed instructions further cause the computer to display an observation message to the user based on the occurrence of a condition.
